(19) United States
(12) Patent Application Publication
(10) Pub. No.: US 2026/0332031 A1
(43) Pub. Date: Oct. 22, 2026

(54) CONTROL SYSTEM FOR SWITCHING CONVERTER

(71) Applicant: Renesas Design (UK) Limited, Bourne End (GB)

(72) Inventors: Jun MIN, San Jose, CA (US); Guang FENG, San Jose, CA (US); Yu RONG, San Jose, CA (US)

(73) Assignee: Renesas Design (UK) Limited, Bourne End (GB)

(21) Appl. No.: 19/181,561

(22) Filed: Apr. 17, 2025

(51) Int. Cl. H02M 1/08; H02M 3/00; H02M 3/156

(52) U.S. Cl. CPC H02M 1/08; H02M 3/01; H02M 3/156

(57) ABSTRACT

A control system for a switching converter. The control system includes a control module having a sense terminal for receiving a sense terminal voltage, and a gate terminal for providing a gate driving signal to switch a first power switch of the switching converter. The control module operates in a first mode, in which the control module compares the sense terminal voltage with a peak threshold voltage and provides the gate driving signal to switch the first power switch to an off state when the sense terminal voltage and the peak threshold voltage are approximately equal; and operates in a second mode, in which the control module detects a voltage characteristic of the sense terminal voltage and provides the gate driving signal to switch the first power switch to an on state after a delay time has elapsed after detection of the voltage characteristic of the sense terminal voltage.

The present disclosure relates to a control system for a switching converter.

### BACKGROUND

A switching power converter controller controls the cycling of a power switch transistor that is in series with an inductor to provide a regulated output voltage or current. When the controller switches the power switch transistor to an on state, a magnetizing current begins to flow through the inductor and the power switch transistor.

In a peak current control methodology, the controller may measure the magnetizing current by monitoring a sense resistor voltage that develops across a sense resistor in series with the power switch transistor. Once the current hits a desired peak as measured through the sense resistor voltage, the controller switches the power switch transistor to an off state. The controller has a corresponding sense pin or terminal to sense the sense resistor voltage. The controller is integrated within an integrated circuit. Each pin or terminal for an integrated circuit raises manufacturing cost.

Therefore, it is advantageous to use the sense terminal for more than just monitoring the sense resistor voltage. For example, the sense terminal may also be used during valley switching of the power switch transistor. Valley switching lowers the device strain that results from the resonant oscillation of the power switch transistor's drain-to-source or drain-to-ground voltage following the cycling of the power switch transistor to the off state.

The controller can switch the power switch transistor to the on state at a valley (a local minimum) of the voltage resonant oscillation by monitoring the drain-to-source or drain-to-ground voltage through the sense terminal. The sense terminal is thus used in a time-shared fashion such that it is used to monitor the sense resistor voltage with respect to the switching off of the power switch transistor and to monitor the drain-to-source or drain-to-ground voltage with respect to the switching on of the power switch transistor.

The controller may thus be deemed to include a time-shared sensing circuit for this monitoring of the sense terminal voltage. However, conventional time-sharing usage of the sense terminal requires an auxiliary winding, which raises manufacturing costs.

### SUMMARY

It is desirable to provide an improved control system for a switching converter. In particular, it is desirable to provide an improved control system that mitigates, or overcomes, one or more of the aforementioned problems.

According to a first aspect of the disclosure there is provided a control system for a switching converter comprising a first power switch, the control system comprising a control module comprising a sense terminal for receiving a sense terminal voltage, a gate terminal for providing a gate driving signal to drive the switching of the first power switch, wherein the control module is configured to operate in a first mode in which the control module is configured to i) compare the sense terminal voltage with a peak threshold voltage, and ii) provide the gate driving signal to switch the first power switch to an off state when the sense terminal voltage and the peak threshold voltage are approximately equal, operate in a second mode in which the control module is configured to i) detect a voltage characteristic of the sense terminal voltage, and ii) provide the gate driving signal to switch the first power switch to an on state after a delay time has elapsed after detection of the voltage characteristic of the sense terminal voltage.

Optionally, the switching converter comprises an energy storage element.

Optionally, the first mode is whilst the first power switch is in the on state, and the second mode is whilst the first power switch is in the off state and a voltage across the first power switch exhibits an oscillation.

Optionally, the delay time is such that the first power switch is switched to the on state at, or near, a local minimum of the voltage across the first power switch.

Optionally, the voltage across the first power switch that exhibits an oscillation during the second mode is the drain-to-source voltage of the first power switch or the drain-to-ground voltage of the first power switch.

Optionally, the voltage characteristic of the sense terminal voltage is i) a negative zero crossing of the sense terminal voltage, ii) a local minimum of the sense terminal voltage, or iii) the sense terminal voltage being approximately equal to a second mode threshold voltage

Optionally, the second mode threshold voltage is a negative threshold voltage.

Optionally, the control module is configured to detect consecutive zero crossings of the sense terminal voltage and the delay time is determined based on a difference between the consecutive zero crossings.

Optionally the consecutive zero crossings are i) a negative zero crossing and a next positive zero crossing, or ii) a positive zero crossing and a next negative zero crossing.

Optionally, the control module is configured to detect a negative zero crossing and a positive zero crossing of the sense terminal voltage and the delay time is determined based on a difference between the negative zero crossing and the positive zero crossing.

Optionally, the control module comprises a first voltage sense circuit configured to i) compare the sense terminal voltage with the peak threshold voltage, ii) provide a first output signal indicating when the sense terminal voltage and the peak threshold voltage are approximately equal, and a second voltage sense circuit configured to i) detect the voltage characteristic of the sense terminal voltage, ii) provide a second output signal indicating that the voltage characteristic has been detected, a gate driver and logic circuit configured to i) receive the first and second output signals, and ii) provide the gate driving signal based on the received first and second output signals.

Optionally, the second voltage sense circuit is configured to detect consecutive zero crossings of the sense terminal voltage and the delay time is determined based on a difference between the consecutive zero crossings.

Optionally the consecutive zero crossings are i) a negative zero crossing and a next positive zero crossing, or ii) a positive zero crossing and a next negative zero crossing.

Optionally, the second voltage sense circuit is configured to detect a negative zero crossing and a positive zero crossing of the sense terminal voltage and the delay time is determined based on a difference between the negative zero crossing and the positive zero crossing.

Optionally, the second voltage sense circuit is configured to provide the second output signal indicating that the voltage characteristic has been detected and that the delay time has elapsed after detection of the voltage characteristic, such that the gate driver and logic circuit is configured to provide the gate driving signal to switch the first power switch to the on state after the delay time has elapsed after detection of the voltage characteristic, in response to the indication provided by the second output signal of the second voltage sense circuit.

Optionally, the control system comprises a sensing circuit for coupling to a first terminal and a second terminal of the first power switch, wherein the sensing circuit is coupled to the sense terminal of the control module for providing the sense terminal voltage, and the switching converter comprises a sense resistor coupled to the first power switch at its second terminal.

Optionally, the sensing circuit comprises a first capacitor coupled between the first and second terminals of the first power switch, wherein the second terminal of the power switch is coupled to the sense terminal of the control module.

Optionally, the sensing circuit comprises a first resistor, wherein the first capacitor is coupled to the second terminal of the first power switch via the first resistor.

Optionally, the sensing circuit comprises a second resistor, wherein the first capacitor is coupled to the sensing terminal of the control module via the second resistor.

Optionally, the sensing circuit comprises a first capacitor and a first resistor coupled in series between the first terminal of the first power switch and a ground terminal, a second resistor coupled between the sense terminal and a first node between the first capacitor and the first resistor, and a third resistor coupled between the sense terminal and the second terminal of the first power switch.

Optionally, the switching converter is a buck converter, a boost converter, a buck-boost converter, a flyback converter, or an asymmetric half bridge converter.

Optionally, the switching converter is a boost converter comprising an inductor, an output capacitor, and an output diode comprising an anode coupled to the inductor and comprising a cathode coupled to the output capacitor.

Optionally, the switching converter is configured to receive an input voltage from a rectifier configured to rectify an AC supply voltage to provide the input voltage.

According to a second aspect of the disclosure there is provided a method of controlling a switching converter comprising a first power switch using a control system comprising a control module comprising a sense terminal for receiving a sense terminal voltage, and a gate terminal for providing a gate driving signal to drive the switching of the first power switch, the method comprising operating the control module in a first mode by i) comparing the sense terminal voltage with a peak threshold voltage, and ii) providing the gate driving signal to switch the first power switch to an off state when the sense terminal voltage and the peak threshold voltage are approximately equal, operating the control module in a second mode by i) detecting a voltage characteristic of the sense terminal voltage, and ii) providing the gate driving signal to switch the first power switch to an on state after a delay time has elapsed after detection of the voltage characteristic of the sense terminal voltage.

It will be appreciated that the method of the second aspect may include using and/or providing features set out in relation to the first aspect and may include other features described herein.

According to a third aspect of the disclosure there is provided a switching converter apparatus comprising a switching converter comprising a first power switch, and a control system comprising a control module comprising a sense terminal for receiving a sense terminal voltage, a gate terminal for providing a gate driving signal to drive the switching of the first power switch, wherein the control module is configured to operate in a first mode in which the control module is configured to i) compare the sense terminal voltage with a peak threshold voltage, and ii) provide the gate driving signal to switch the first power switch to an off state when the sense terminal voltage and the peak threshold voltage are approximately equal, operate in a second mode in which the control module is configured to i) detect a voltage characteristic of the sense terminal voltage, and ii) provide the gate driving signal to switch the first power switch to an on state after a delay time has elapsed after detection of the voltage characteristic of the sense terminal voltage.

It will be appreciated that the switching converter apparatus of the third aspect may include features set out in relation to the first and/or second aspects and may include other features as described herein.

### BRIEF DESCRIPTION OF THE DRAWINGS

The disclosure is described in further detail below by way of example and with reference to the accompanying drawings in which:

FIG. 1 is a schematic of an example traditional switching power converter;

FIG. 2A is a schematic of a control system for a switching converter in accordance with a first embodiment of the present disclosure, FIG. 2B is a timing graph showing example waveforms for a practical implementation of the control system and the switching converter of FIG. 2A;

FIG. 3A is a schematic a further embodiment of the control system for the switching converter, in accordance with a second embodiment of the present disclosure, FIG. 3B is a timing graph showing example waveforms for a practical implementation of the control system and the switching converter of FIG. 3A;

FIG. 4 is a schematic a further embodiment of the control system for the switching converter, in accordance with a third embodiment of the present disclosure;

FIG. 5 is a schematic a further embodiment of the control system for the switching converter, in accordance with a fourth embodiment of the present disclosure;

FIG. 6 is a schematic a further embodiment of the control system for the switching converter, in accordance with a fifth embodiment of the present disclosure;

FIG. 7 is a flow chart of a method of controlling the switching converter using the control system of any of the embodiments described herein, and in accordance with the understanding of the skilled person;

FIG. 8 is a schematic a further embodiment of the control system for the switching converter, in accordance with a sixth embodiment of the present disclosure;

FIG. 9 is a schematic a further embodiment of the control system for the switching converter, in accordance with a seventh embodiment of the present disclosure;

FIG. 10 is a schematic a further embodiment of the control system for the switching converter, in accordance with an eighth embodiment of the present disclosure;

FIG. 11A is a schematic of an example series-type sensing circuit, FIG. 11B is a schematic of an example parallel-type sensing circuit;

FIG. 12A is an alternative schematic of the embodiment presented in FIG. 6, FIG. 12B is a schematic of the equivalent circuit of the sensing circuit during the on time of the power switch, FIG. 12C is a schematic of the equivalent circuit of the sensing circuit during the off time of the power switch;

FIG. 13A is a schematic a further embodiment of the control system for the switching converter, in accordance with a ninth embodiment of the present disclosure, FIG. 13B is a timing graph showing example waveforms for a practical implementation of the control system and the switching converter of FIG. 13A, FIG. 13C is a further timing graph showing example waveforms for a practical implementation of the control system and the switching converter of FIG. 13A;

FIG. 14 is a schematic a further embodiment of the control system for the switching converter, in accordance with a tenth embodiment of the present disclosure;

FIG. 15 is a schematic a further embodiment of the control system for the switching converter, in accordance with an eleventh embodiment of the present disclosure; and

FIG. 16 is a schematic a further embodiment of the control system for the switching converter, in accordance with a twelfth embodiment of the present disclosure.

### DETAILED DESCRIPTION

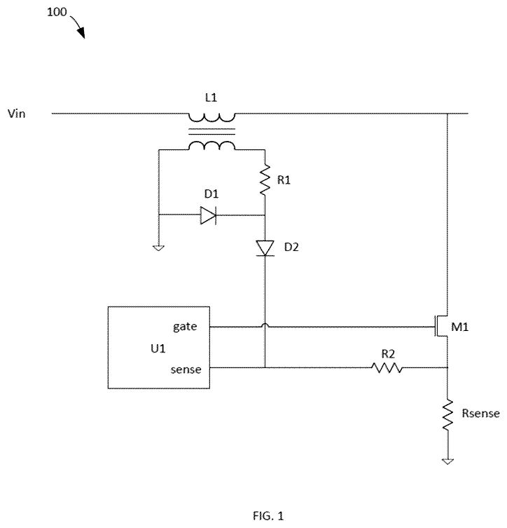

FIG. 1 is a schematic of an example traditional switching power converter 100 that includes a primary controller U1 having a time-shared sense terminal. A power switch transistor M1 has its source coupled to ground through a sense resistor Rsense. A drain of the power switch transistor M1 is coupled to a first terminal of an inductor L1. A second terminal of the inductor L1 is coupled to a node for an input voltage Vin, which may be obtained from the rectification of an AC power supply voltage.

When the primary controller U1 switches on the power switch transistor M1 by driving the gate of the power switch transistor through a gate drive terminal, the power switch transistor M1 switches on such that a magnetizing current conducts from the input voltage node through the inductor L1, then through the power switch transistor M1, and finally through the sense resistor to ground.

As the magnetizing current ramps up, a sense resistor voltage across the sense resistor also increases. The primary controller U1 has a sense terminal coupled through a resistor R2 to the source of the power switch transistor M1 to monitor the sense resistor voltage to determine whether a desired peak current has been achieved through the power switch transistor M1.

The switching power converter 100 includes an auxiliary winding AUX that is magnetically coupled to the inductor L1, to assist the valley-mode switching of the power switch transistor M1. The auxiliary winding is used for valley-mode switching control of the power switch transistor.

A first terminal of the auxiliary winding is coupled to ground and to an anode of a diode D1 whereas a second terminal of the auxiliary winding is coupled through a resistor R1 to an anode of a diode D2. A cathode of the diode D1 is coupled to the anode of the diode D2. A cathode of the diode D2 is coupled to the sense terminal.

When the power switch transistor cycles off and the drain-to-source voltage of the power switch transistor M1 begins resonantly oscillating, the diode D2 becomes forward biased such that a current flows through the resistor R1, the diode D2, the resistor R2, and the sense resistor to ground. It can be shown that when the voltage across resistor R2 is zero, the drain-to-source voltage of the power switch transistor M1 is near a local minimum (a valley) of the resonant oscillation, that is approximately a quarter of an oscillation period away from the valley.

However, the sensing for valley-mode switching becomes problematic during the zero crossing times of the AC power supply voltage, such that the rectified input voltage Vin is close to an output voltage of the switching converter.

At such times, there may not be sufficient voltage across the auxiliary winding to forward bias the diode D2 such that the sense terminal dips to zero despite a valley not being reached. Even if there is sufficient voltage to forward bias the diode D2, the use of the auxiliary winding requires a custom manufacture of inductor L1 and raises manufacturing costs.

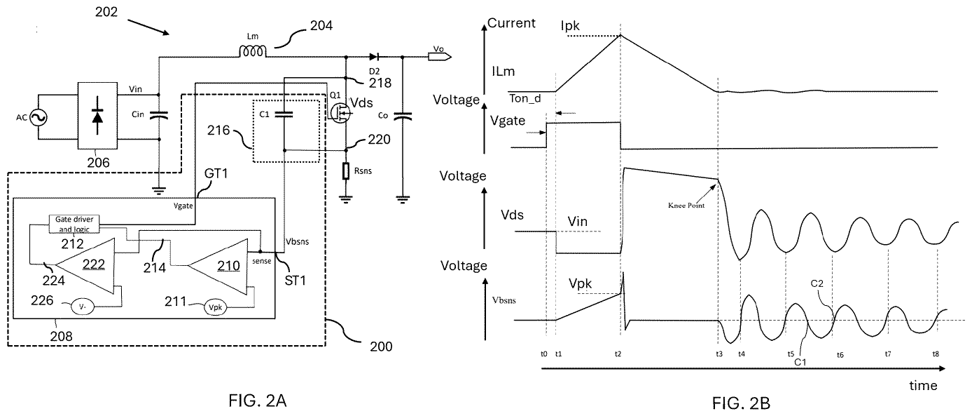

FIG. 2A is a schematic of a control system 200 for a switching converter 202 comprising a power switch Q1, in accordance with a first embodiment of the present disclosure. The switching converter 202 may comprise an energy storage element 204.

In the present example, the switching converter 202 is a boost converter. However, it will be appreciated that in further embodiments, the control system 200 may be used with other switching converters, such as a buck converter, a buck-boost converter, a flyback converter, or an asymmetric half bridge converter.

In the present example, the boost converter comprises an inductor Lm (which is the energy storage element 204) an output capacitor Co and an output diode D2 comprising an anode coupled to the inductor Lm and a cathode coupled to the output capacitor Co. The inductor Lm may be referred to as a “boost inductor”. In the present example, the power switch Q1 is a power switch transistor. Therefore we may refer to the power switch Q1 as the power switch transistor Q1.

The inductor Lm is coupled between an output terminal of the rectifier 206 and an anode of the output diode D2. The power switch transistor Q1 has a drain coupled to the anode of the output diode D1.

In the present example, during operation a rectifier 206, such as diode bridge rectifier, rectifies an AC voltage to provide a rectified input voltage Vin stored on an input capacitor Cin. A positive terminal of the input capacitor Cin is coupled to a first terminal of the inductor Lm. A second terminal of the inductor Lm is coupled to a drain of a power switch transistor Q1. A source of the power switch transistor Q1 is coupled to ground through a sense resistor Rsns.

The control system 200 comprises a control module 208. The control module 208 comprises a sense terminal ST1 for receiving a sense terminal voltage Vbsns. The control module 208 further comprises a gate terminal GT1 for providing a gate driving signal Vgate to drive the switching of the power switch Q1. The gate driving signal Vgate, may be referred to as the terminal voltage of the gate terminal GT1.

The control module 208 is configured to operate in a first mode to compare the sense terminal voltage Vbsns with a peak threshold voltage Vpk, and to provide the gate driving signal Vgate to switch the power switch Q1 to an off state when the sense terminal voltage Vbsns and the peak threshold voltage Vpk are approximately equal.

In the present example, the first mode occurs when the power switch Q1 is in an on state, and corresponds to peak current control as described previously.

During operation, the control module 208 controls the switching of the power switch transistor Q1 by driving its gate through the gate terminal GT1. When the control module 208 asserts the gate voltage Vgate, the power switch transistor Q1 switches on so that a magnetizing current flows from the positive terminal of the input capacitor Cin through the boost inductor Lm and from the boost inductor Lm through the channel of the power switch transistor Q1 to ground through the sense resistor Rsns.

As the magnetizing current ramps up, the sense resistor voltage across the sense resistor Rsns also increases.

The control module 208 has its sense terminal ST1 coupled to the source of the power switch transistor Q1 to monitor the sense resistor voltage so as to determine whether a desired peak current has been obtained.

With the power switch transistor Q1 switched on, the sense resistor voltage is proportional to the transistor's drain current (Id) through Ohm's law. The sense terminal voltage Vbsns during the on-time of the power switch transistor Q1 thus equals a product of Rsns and Id, where Rsns is also the resistance of the sense resistor. During the on time of the power switch Q1, the sense terminal voltage is as follows:

Vbsns=Id×Rsns (1)

The control module 208 may comprise a voltage sense circuit 210 to compare the sense terminal voltage Vbsns to the peak threshold voltage Vpk, thereby providing a determination of whether the sense resistor voltage indicates that the peak current Ipk has been obtained. In the present example, the voltage sense circuit 210 is a comparator that compares the sense terminal voltage Vbsns to a peak voltage source 211 that is associated with the peak threshold voltage Vpk to be detected.

The control module 208 may further comprise a gate driver and logic circuit 212. During operation, the voltage sense circuit 210 provides an output signal 214 to the gate driver and logic circuit 212 that indicates that the peak threshold voltage Vpk has been reached by the sense terminal voltage Vbsns, and in response the gate driver and logic circuit 212 may assert the terminal voltage Vgate to switch off the power switch transistor Q1.

The gate driver and logic circuit 212 functions to respond to the output signal 214 from the voltage sense circuit 210 when peak current mode switching is active.

The gate driver and logic circuit 212 may discharge a voltage of the gate terminal of the power switch Q1 in response to the indication from the comparator 210 that the voltage of the sense terminal Vbsns equals the peak threshold voltage Vpk.

The control module 208 is further configured to operate in a second mode in which the control module is configured to detect a voltage characteristic of the sense terminal voltage Vbsns and to provide the gate driving signal Vgate to switch the power switch Q1 to the on state after a delay time has elapsed after detection of the voltage characteristic of the sense terminal voltage Vbsns.

In the present example, the second mode occurs when the power switch Q1 is in the off state and a voltage across the power switch Q1 exhibits an oscillation. The voltage across the power switch Q1 that exhibits an oscillation during the second mode may, for example, be the drain-to-source voltage of the power switch Q1 or the drain-to-ground voltage of the power switch Q1.

The second mode may correspond to the valley mode of operation as described previously.

With the power switch transistor Q1 switched off, the output diode D2 having an anode coupled to the second terminal of the boost inductor Lm and a cathode coupled to a node for an output voltage Vo becomes forward biased by the magnetizing current from the boost inductor Lm. The magnetizing current then flows through the output diode D2 to charge the output capacitor Co with the output voltage Vo. As the stored magnetic energy in the boost inductor Lm is discharged, the magnetizing current ramps down to zero. With the magnetizing current discharged to zero, the drain-to-source voltage Vds of the power switch transistor Q1 begins to resonantly oscillate.

The control system 200 may comprise a sensing circuit 216 coupled to a first terminal 218 and a second terminal 220 of the power switch Q1. The sensing circuit 216 is coupled to the sense terminal ST1 of the control module 208, with the sense terminal voltage Vbsns being provided by the sensing circuit 216 during operation. The sense resistor Rsns is coupled to the power switch Q1 at its second terminal 220. The sensing circuit 216 may be referred to as a “time shared sensing circuit”.

In the present embodiment, the sensing circuit 216 comprises a capacitor C1 that is coupled between the terminals 218, 220 of the power switch Q1. In the present embodiment, the second terminal 220 of the sensing circuit 216 is coupled to the sense terminal ST1 of the control module 208.

The capacitor C1 coupled between the drain and source of the power switch transistor Q1 allows the control module 208 to monitor the resonant oscillation of the voltage across the power switch Q1, so that the power switch transistor Q1 may be switched on in a valley mode of operation without the use of an auxiliary winding.

A resistor-capacitor circuit may be formed comprising the sense resistor Rsns coupled between the source of the power switch transistor Q1 and ground and the capacitor C1 coupled to the drain of the power switch transistor Q1. The resistor-capacitor circuit may be coupled between the drain and source of the power switch transistor Q1.

The resonant oscillation of the drain-to-source or drain-to-ground voltage excites a current IC1 through the resistor-capacitor RC circuit formed by the capacitor C1 and the sense resistor Rsns that conducts to ground. The sense terminal voltage Vbsns during the resonant oscillation equals a product of Rsns and IC1. As IC1 equals a product of the capacitance C1 with the first-order time derivative (dVds/dt) of the drain-to-source voltage Vds, the sense terminal voltage is as follows:

$$Vbsns = Rsns \times C 1 \times ( \frac{dVds}{dt} ) \qquad ( 2 )$$

The derivative introduces an approximately 90° phase shift between the sense terminal voltage Vbsns and the drain-to-source voltage Vds of the power switch transistor Q1.

FIG. 2B is a timing graph showing example waveforms for a practical implementation of the control system 200 and the switching converter 202 of FIG. 2A as the power switch Q1 is switched from off to on, then from on to off.

The following waveforms are shown in FIG. 2B:
ILm is the magnetizing current flowing through the inductor Lm
Vgate is the gate driving signal as provided from the gate terminal GT1
Vds is the drain-to-source voltage of the power switch Q1
Vbsns is the sense terminal voltage

At a time t0, the control module 208 asserts the terminal voltage Vgate. After an on-delay Ton_d, the magnetizing current ILm begins to ramp up at a time t1. At the same time, Vds drops to zero and the sense terminal voltage Vbsns begins to ramp up also.

At a time t2, the sense terminal voltage Vbsns has reached the threshold voltage Vpk that indicates that the magnetizing current ILm has reached the desired peak current Ipk. The terminal voltage Vgate thus drops to zero at the time t2 to switch off the power switch transistor Q1 (the turn-off delay of the power switch transistor Q1 is not shown in FIG. 2A for illustration clarity). As a result of this switching off, the drain-to-source voltage Vds of the power switch transistor Q1 increases sharply beginning at the time t2 and then gradually declines as the magnetizing current ILm declines from its peak.

When the magnetizing current decreases to zero at a time t3, the drain-to-source voltage Vds passes through its “knee point” such that it begins to decline sharply before resonantly oscillating. The knee point is a hallmark of a discontinuous conduction mode of operation. In contrast, the magnetizing current does not discharge to zero in a continuous conduction mode of operation such that there is no resonant oscillation of the drain-to-source voltage Vds during a continuous conduction mode of operation.

The approximately 90° phase shift between the sense terminal voltage Vbsns and the drain-to-source voltage Vds of the power switch transistor Q1 can be observed in the waveforms.

The local minimums (valleys) in this resonant oscillation of Vds correspond to positive zero crossings of the sense terminal voltage Vbsns due to the phase shift between the sense terminal voltage Vbsns and Vds. The sense terminal voltage Vbsns has positive zero crossings (going from below zero to higher than the zero) at times t4, t5, t6, 7, and t8. The drain-to-source voltage Vds has a corresponding local minimum (valley) at each one of these threshold crossing times. Therefore, the times t4, t5, t6, t7, and t8 are the ideal moments to turn on the power switch Q1 at the Vds valley, which corresponds to the positive zero crossing of the Vbsns signal.

However, due to sensing delays, gate driver delays, and other factors, a timing offset always exists in practical implementation. The timing offset means that having the control module 208 responsive to the positive zero crossing of the sense terminal voltage Vbsns would result in the power switch Q1 being turned on after the valleys of the drain-to-source voltage Vds, thereby resulting in non-optimal operation.

To compensate for the timing offset, the control module 208 detects a specific characteristic of the sense terminal voltage Vbsns and then acts to switch the power switch Q1 to the on state after a delay time has elapsed. This approach provides additional time for timing offset compensation.

The delay time may be such that the power switch Q1 is switched to the on state at, or near, a local minimum of the voltage across the power switch Q1.

The voltage characteristic of the sense terminal voltage Vbsns that is detected may, for example, be a negative zero crossing of the sense terminal voltage Vbsns, a local minimum of the sense terminal voltage Vbsns, or the sense terminal voltage Vbsns being approximately equal to a specific threshold voltage value. The threshold voltage value may or may not be close to zero and may be either positive or negative.

In a specific example, the voltage characteristic may be the negative zero crossing of the sense terminal voltage Vbsns, when the sense terminal voltage crosses zero volts from a positive value to a negative value. Depending on the desired switching frequency, the control module 208 may select the appropriate local minimum (valley) of the drain-to-source voltage Vds for turning on the power switch Q1 by monitoring the negative threshold crossing of the Vbsns signal. After detecting this negative threshold crossing, the control module 208 may apply a suitable time delay (“the delay time”) to ensure that the power switch Q1 turns on as close as possible to the local minimum (valley) of its drain-to-source voltage Vds.

In summary, in the present example, the control module 208 may thus determine to trigger a valley-mode switching on of the power switch transistor Q1 after the delay time has elapsed, after the sense terminal voltage Vbsns dips to zero with a negative zero crossing.

The delay time may be determined based on the time between two consecutive zero crossings of the sense terminal voltage Vbsns within the current switching cycle or any pair of consecutive zero crossings from previous switching cycles, as well as system-level delays such as gate driver delay, turn-on delay, and sensing delay. The delay time may, for example, be the difference between a negative zero crossing and the next positive zero crossing.

The delay time may be determined based on the time between a negative zero crossing and a positive zero crossing of the sense terminal voltage Vbsns within the current switching cycle or any pair of negative and positive zero crossings from previous switching cycles, as well as system-level delays such as gate driver delay, turn-on delay, and sensing delay. The delay time may, for example, be the difference between negative and positive zero crossings.

In further embodiments, the delay time may be based on the time between two consecutive threshold voltage value crossings of the sense terminal voltage Vbsns or two consecutive local minimums of the sense terminal voltage Vbsns. The delay time may be determined based on the current switching cycle or historic data. The delay time may also take into account system-level delays such as gate driver delay, turn-on delay, and sensing delay

The delay time may be adjusted by the control system 200, set as a fixed value, or implemented as a combination of both.

In a specific embodiment, the control module 208 is configured to detect consecutive zero crossings of the sense terminal voltage Vbsns (labelled as C1 and C2 in FIG. 2B). The control module 208 is further configured to determine the delay time based on the difference between the consecutive zero crossings C1, C2.

In the present example the zero crossing C1 is a negative zero crossing, and the zero crossing C2 is the next positive zero crossing after the negative zero crossing. The delay time may be the time difference between the zero crossings C1, C2 which may then be applied to subsequent power cycles.

In the present embodiment, the control module 208 further comprises a voltage sense circuit 222 that is configured to detect the voltage characteristic of the sense terminal voltage Vbsns and provide an output signal 224 indicating that the voltage characteristic has been detected. The gate driver and logic circuit 212 is configured to switch off the power switch transistor Q1 after the delay time has elapsed, after the voltage characteristic has been detected as indicated by the output signal 224.

In the present embodiment, the voltage sense circuit 222 is a comparator that compares the sense terminal voltage Vbsns to a threshold voltage source 226 that is associated with the voltage characteristic to be detected, such as the crossing to a negative voltage.

The gate driver and logic circuit 212 functions to respond to the output signal 224 from the voltage sense circuit 222 when valley-mode switching is active.

The gate driver and logic circuit 212 may function to assert the voltage of the gate drive terminal after a certain delay time following an indication from the comparator 222 that the negative zero crossing of sense voltage Vbsns was detected.

During a valley-mode switching of the power switch transistor Q1, the gate driver and logic circuit 212 may alternate between responding to the output signal 214 from the voltage sense circuit 210 and the output signal 224 from the voltage sense circuit 222 depending upon whether the control system 200 is controlling the on time or the off time, of the power switch transistor Q1.

It will be appreciated that the comparator functioning as the voltage sense circuit 210 may be used in alternative modes of operation such as a continuous conduction mode. In that regard, a valley mode of operation may require that the power switch transistor Q1 be cycled in a discontinuous conduction mode of operation.

It will be appreciated that negative threshold and/or negative zero crossing detection may be provided by circuits other than a comparator. For example, the voltage sense circuit 222 may comprise a voltage change rate detection circuit or a circuit that compares the original sensed signal with a delayed version to determine the threshold crossing timing.

In summary, the signal processing within the control module 206 as provided by the voltage sense circuits 210, 222 processes the sensed signal to ensure that the power switch Q1 turns on when the terminal voltage Vsns is near or at its crossing to a positive value during a valley (of power switch Vds) in the resonant oscillation.

It will be appreciated that the signal processing circuitry within the control module 208 may be implemented using different circuits in further embodiments, in accordance with the skilled person, whilst still providing the functionality as described.

The embodiment presented in FIG. 2A is an improved switching power converter 202 and control system 200, in which an RC circuit is used for valley-mode switching control of the power switch transistor Q1. In the present embodiment, the control system 200 includes a time-shared sensing circuit 216 that may advantageously monitor the sense terminal voltage Vbsns for both peak current and valley-mode switching without the use of an auxiliary winding.

The use of the capacitor C1 with the sense resistor Rsns to form an RC circuit that couples between the drain of the power switch transistor Q1 and ground, in conjunction with the corresponding control module 208, is advantageous as the resulting valley-mode switching will no longer be subjected to inaccuracies when the AC input voltage is close output voltage Vo cycle, that would otherwise occur if an auxiliary winding is used, such as discussed for the switching power converter 100.

In addition, manufacturing costs of the switching power converter 202 are reduced as compared to switching power converter 100 because the auxiliary winding is eliminated. In this fashion, the boost inductor Lm may be a conventional inductor as compared to a custom boost inductor that must be magnetically coupled to an auxiliary winding in the switching converter 100.

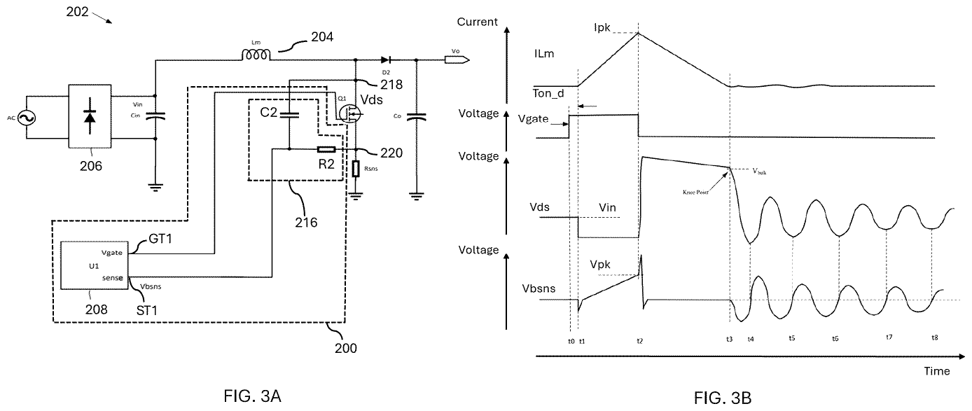

FIG. 3A is a schematic a further embodiment of the control system 200 for the switching converter 202, in accordance with a second embodiment of the present disclosure. The control system 200 of the present embodiment illustrates an improvement over the control system 200 of FIG. 2A, but otherwise functions substantially as described for the control system 200 of FIG. 2A, in accordance with the understanding of the skilled person.

In the present embodiment, the sensing circuit 216 comprises a capacitor C2 and a resistor R2. The capacitor C2 is coupled to the first terminal 218 of the power switch Q1 and the second terminal 220 of the power switch Q2 via the resistor R2.

Considering the embodiment presented in FIG. 2A, the capacitor C1 is preferably able to withstand the relatively high values of the drain-to-source voltage Vds such as when the power switch transistor Q1 is switched off as shown in FIG. 2B at the time t1. The present embodiment provides an alternative control system 200 that uses the capacitor C2 which has a reduced capacitance as compared to the capacitor C1.

The AC voltage source, the rectifier 206, the input capacitor Cin, the boost inductor Lm, the output diode D2, the output capacitor Co, the power switch transistor Q1, and the sense resistor Rsns are all arranged in the switching converter 202 of the present embodiment, as discussed for the switching converter 202 of FIG. 2A. However, the capacitor C1 has been replaced with the capacitor C2 in series with a resistor R2 having a terminal coupled to the source of the power switch transistor Q1.

In the present embodiment, during the resonant oscillation of the drain-to-source voltage Vds, it can be shown that the sense terminal voltage Vbsns of the control module 208 is as follows:

$$Vbsns = ( Rsns + R 2 ) \times C 1 \times ( \frac{dVds}{dt} ) \qquad ( 3 )$$

where R2 is also the resistance of the resistor R2 and C2 is also the capacitance of the capacitor C2

As compared to the same slew rate for the resonant oscillation, it can be seen that the capacitor C2 may have a smaller capacitance than capacitor C1 to produce the same development of the sense terminal voltage Vbsns.

Since the capacitor C1 is a relatively high voltage capacitor, the reduction in capacitance for capacitor C2 in the switching power converter 202 of FIG. 3A may produce substantial manufacturing cost savings. The combination of the capacitor C2, the resistor R2 and the sense resistor Rsns form an RC circuit that is coupled between the source of the power switch transistor Q1 and ground.

The switching power converter 202 of FIG. 3A is a boost converter as discussed for the switching converter 202 of FIG. 2A. However, it will be appreciated that the capacitor C2 and resistor R2 in combination with the sense resistor Rsns may be advantageously used with other types of switching power converters for valley-mode switch control. The control module 208 may be implemented as shown in FIG. 2A.

FIG. 3B is a timing graph showing example waveforms for a practical implementation of the control system 200 and the switching converter 202 of FIG. 3A as the power switch Q1 is switched from off to on, then from on to off.

At the time t0, the control module 208 asserts the terminal voltage Vgate. After an on-delay (Ton_d), the magnetizing current ILm begins to ramp up at a time t1 after a negative pulse due to the inclusion of the resistor R2. At the same time, the drain-to-source voltage Vds drops to zero and the sense terminal voltage Vbsns begins to ramp up also.

At a time t2, the sense terminal voltage Vbsns has reached the threshold voltage Vpk that indicates that the magnetizing current ILm has reached the desired peak current Ipk. The terminal voltage Vgate thus drops to zero at the time t2 to switch off the power switch transistor Q1 (the turn-off delay of the power switch transistor Q1 is not shown in FIG. 3B for illustration clarity).

As a result of this switching off, the drain-to-source voltage Vds of the power switch transistor Q1 increases sharply beginning at the time t2 and then gradually declines as the magnetizing current ILm declines from its peak.

When the magnetizing current decreases to zero at a time t3, the drain-to-source voltage Vds passes through its knee point such that it begins to decline sharply before resonantly oscillating. The sense terminal voltage Vbsns has negative zero crossings (going from positive to negative as zero is crossed). The drain-to-source voltage Vds may have a corresponding local minimum (valley) after a delay time following each one of these negative threshold crossing times.

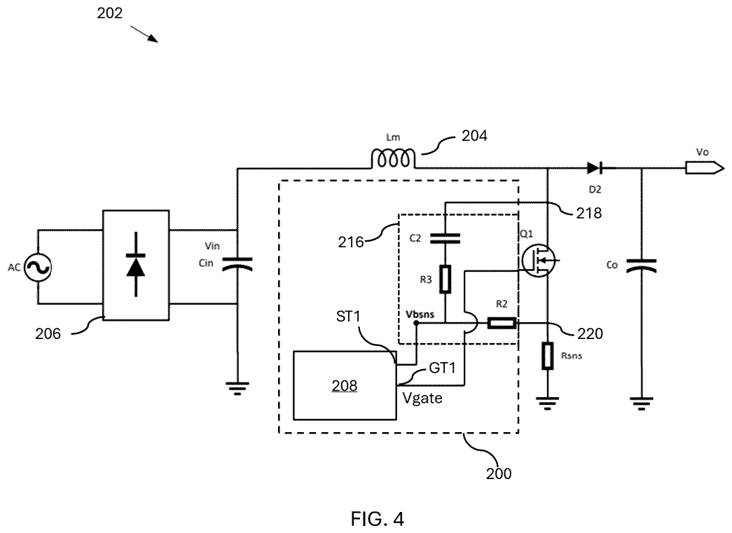

FIG. 4 is a schematic a further embodiment of the control system 200 for the switching converter 202, in accordance with a third embodiment of the present disclosure. The control system 200 of the present embodiment illustrates an improvement over the control system 200 of FIG. 3A, but otherwise functions substantially as described for the control system 200 of FIG. 2A, in accordance with the understanding of the skilled person.

In the present embodiment, the sensing circuit 216 further comprises a resistor R3. The capacitor C2 is coupled to the sensing terminal ST1 of the control module 208 via the resistor R3.

A comparator implemented as the voltage sense circuit 222 (for example as shown in FIG. 2A) should be robust to the negative pulsing of the sense terminal voltage Vbsns at the time t1. The present embodiment substantially eliminates this negative pulsing.

The AC voltage source, the rectifier 206, the input capacitor Cin, the boost inductor Lm, the output diode D2, the output capacitor Co, the capacitor C2, the power switch transistor Q1, the resistor R2, and the sense resistor Rsns are all arranged in the the present embodiment as discussed for the embodiment shown in FIG. 3A.

The resistor R3 is positioned between the capacitor C2 and the resistor R2. During the resonant oscillation of the drain-to-source voltage Vds in the switching converter 202 of the present embodiment, the resistor R3 has no effect on the sense terminal voltage Vbsns. Therefore Vbsns will be provided by equation (3) as discussed for the embodiment presented in FIG. 3A. However, the inclusion of the resistor R3 substantially suppresses the negative current that would otherwise flow through the capacitor C2 at time t1 of FIG. 3A and thus suppresses the negative voltage spike that would otherwise occur for the sense terminal voltage Vbsns.

The inclusion of the resistor R3 will increase the RC time constant of the RC circuit formed by the combination of the capacitor C2, the resistor R3, the resistor R2, and the sense resistor Rsns. This RC circuit couples between the drain of the power switch transistor Q1 and ground. If the resistor R3 is too large, it may introduce a sensing delay with respect to the use of the sense terminal voltage Vbsns to detect the valleys.

The switching converter 202 of the present embodiment is a boost converter but it will be appreciated that the RC sensing circuit formed by the sense resistor Rsns, the resistors R2 and R3, and the capacitor C2 may be used in other types of switching power converters. The resistors R2 and R3 are also denoted herein as a pair of resistors. The sense terminal ST1 is coupled to a node between the resistors in this pair of resistors R2, R3.

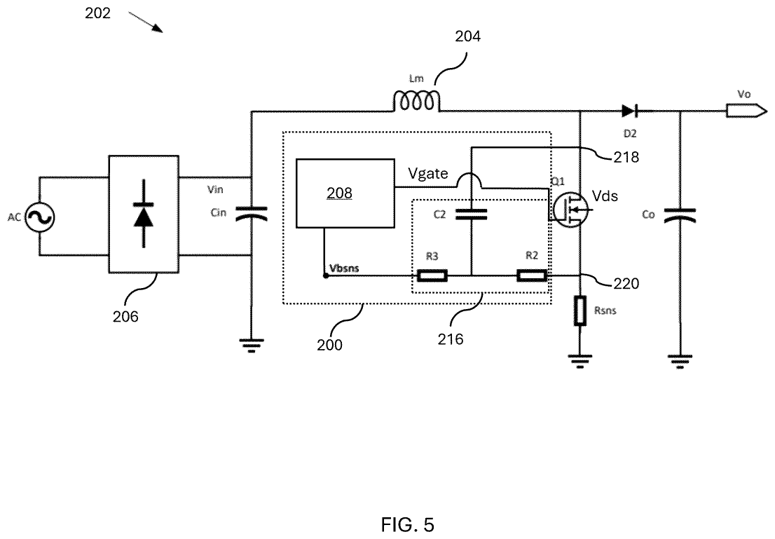

FIG. 5 is a schematic a further embodiment of the control system 200 for the switching converter 202, in accordance with a fourth embodiment of the present disclosure. The control system 200 of the present embodiment functions substantially as described for the control system 200 of FIG. 4, in accordance with the understanding of the skilled person.

The present embodiment mitigates the negative voltage spike at the switching on of the power switch transistor Q1 without impacting the RC time constant. The AC voltage source, the rectifier 206, the input capacitor Cin, the boost inductor Lm, the output diode D2, the output capacitor Co, the capacitor C2, the power switch transistor Q1, the resistor R2, and the sense resistor Rsns are all arranged as discussed for the embodiment presented in FIG. 4. However, in the present embodiment, the resistor R3 is coupled between the capacitor C2 and the sense terminal ST1 for the control module 208.

The resistor R3 suppresses the negative current but does not factor into the RC circuit formed by the capacitor C2, the resistor R2, and the sense resistor Rsns while this RC circuit conducts during the resonant oscillation of the drain-to-source voltage Vds.

The RC circuit formed by the serial combination of the capacitor C2, the resistor R2, and the sense resistor Rsns is coupled between the drain of the power switch transistor Q1 and ground. The resistor R2 has a first terminal coupled to the source of the power switch transistor Q1. The resistor R3 has a second terminal coupled to the sense terminal ST1 of the control module 208 and has a first terminal coupled to a second terminal of the resistor R2.

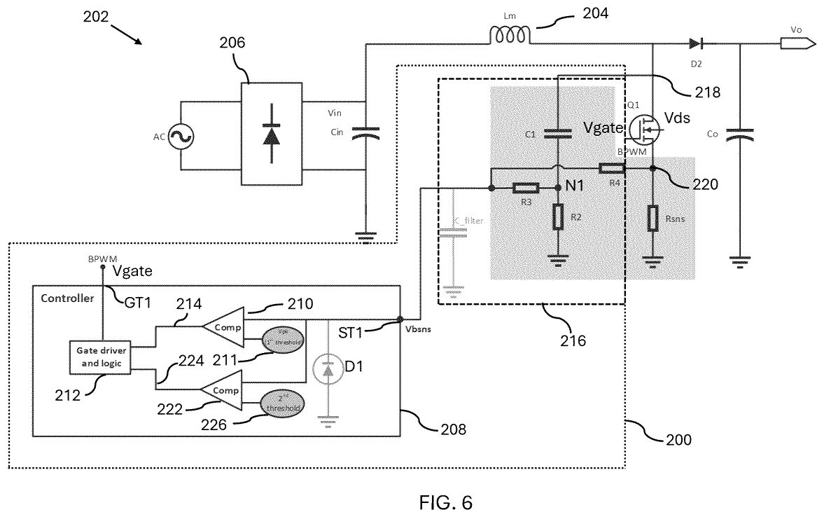

FIG. 6 is a schematic a further embodiment of the control system 200 for the switching converter 202, in accordance with a fifth embodiment of the present disclosure. The control system 200 of the present embodiment functions substantially as described for the control system 200 of FIG. 5, in accordance with the understanding of the skilled person.

The previous control system 200 embodiments of FIG. 2A, FIG. 3A, FIG. 4 and FIG. 5 can be categorized as having series-type sensing circuits 216, where the voltages across Rsns and R2 are combined in series before being sensed at the sense pin ST1.

However, this series-type sensing circuit lacks flexibility in certain applications. In such cases, a parallel-type time-shared sensing circuit can be utilized as shown in FIG. 6.

In the present embodiment, the sensing circuit 216 is a parallel-type sensing circuit comprising the capacitor C1 and the resistor R2 coupled in series between the first terminal 218 of the power switch Q1 and the ground terminal. The sensing circuit 216 further comprises the resistor R3 coupled between the sense terminal ST1 and a node N1 between the capacitor C1 and the resistor R2. The sensing circuit 216 further comprises a resistor R3 coupled between the sense terminal ST1 and the second terminal 220 of the power switch Q1.

The embodiment shown in FIG. 6 provides design flexibility in tuning the sensing gain and RC filter gain (with an optional capacitor filter C_filter) for different paths.

An optional diode D1 is for clamping the negative voltage so to protect the control system 200 integrated circuit (IC). The AC voltage source, the rectifier 206, the input capacitor Cin, the boost inductor Lm, the output diode D2, the output capacitor Co, the capacitor C2, and the power switch transistor Q1 are all arranged in the present embodiment as discussed for embodiment presented in FIG. 5.

However, in this parallel-type sensing circuit, the resistor R2 is coupled to ground rather than source of power switch Q1, so the sensed signal is the drain-to-ground voltage rather than drain-to-source voltage. The capacitor C1 is connected in series with the resistor R2 to form a capacitor-resistor circuit, where the first terminal of the capacitor C1 is coupled to the drain of the power switch transistor Q1, and the second terminal of the capacitor C1 is connected to the resistor R2. The other terminal of the resistor R2 is coupled to ground.

The second terminal of the capacitor C1 is also coupled to the time-shared sense terminal ST1 via the resistor R3. The sense resistor Rsns is coupled between the source of the power switch transistor Q1 and ground, and the source of the power switch Q1 is also coupled to the same time-shared sense terminal ST1 of the control module 216 via the resistor R4.

During the turning on period of power switch transistor Q1, the sensing terminal of the controller voltage Vbsns is as follows:

$$Vbsns = V\_Rsns \times \frac{( R 3 + R 2 )}{( R 3 + R 2 + R 4 )} \qquad ( 4 )$$

where V_Rsns is the voltage across the sense resistor Rsns during the turning on period of the power switch Q1.

During the resonant oscillation after turning off of power switch transistor Q1, Vbsns is as follows:

$$Vbsns = V\_R2 \times \frac{( R 4 + Rsns )}{( R 3 + Rsns + R 4 )} \qquad ( 5 )$$

where V_R2 is the voltage across the resistor R2 during the resonant oscillation after the turning off of the power switch transistor Q1.

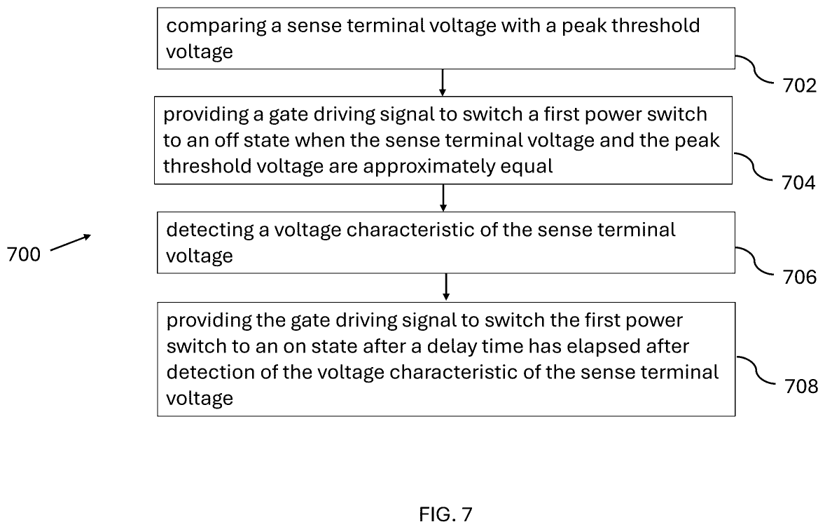

FIG. 7 is a flow chart of a method 700 of controlling the switching converter 202 using the control system 200 of any of the embodiments described herein, and in accordance with the understanding of the skilled person.

The method 700 comprises comparing the sense terminal voltage Vbsns with the peak threshold voltage Vpk at a step 702 when the system is operating in the first mode.

The method 700 further comprises providing the gate driving signal Vgate to switch the power switch Q1 to the off state when the sense terminal voltage Vbsns and the peak threshold voltage Vpk are approximately equal at a step 704 when the system is operating in the first mode.

The method 700 further comprises detecting a voltage characteristic of the sense terminal voltage Vbsns at a step 706 when the system is operating in the second mode. The method 700 further comprises providing the gate driving signal Vgate to switch the power switch Q1 to the on state after a delay time has elapsed after detection of the voltage characteristic of the sense terminal voltage Vbsns, at a step 708 when the system is operating in the second mode.

As discussed previously, the first mode may occur when the power switch Q1 is in the on state, and corresponds to peak current control as described previously.

As discussed previously, the second mode occurs when the power switch Q1 is in the off state and a voltage across the power switch Q1 exhibits an oscillation. The second mode may correspond to the valley mode of operation.

During peak current control, the act of monitoring the sense resistor voltage through the sense terminal ST1 of the control system 200 enables the control system 200 to determine when the sense resistor voltage equals a peak voltage whilst the power switch transistor Q1 is in the on state. The power switch transistor Q1 may then be switched off in response to a determination that the sense resistor voltage was equal to the peak voltage Vpk.

During valley mode control, the act of monitoring the sense terminal voltage Vbsns through the sense terminal ST1 of the control system 200 enables the control system 200 to determine a voltage characteristic of the sense terminal voltage Vbsns when the drain-to-source or drain-to-ground voltage of the power switch Q1 is oscillating. The characteristic that is detected may, for example, be the negative zero crossing. The power switch transistor Q1 may then be turned off after a certain delay following detection of the negative zero crossing of the sense terminal voltage Vbsns, with the delay being chosen such that the power switch Q1 is turned off at, or close to, a local minimum of the voltage oscillation.

The delay time may be determined based on the time between two consecutive zero crossings of the sense terminal voltage Vbsns within the current switching cycle or any pair of consecutive zero crossings from previous switching cycles, as well as system-level delays such as gate driver delay, turn-on delay, and sensing delay. The delay time may be adjusted by the control system 200, set as a fixed value, or implemented as a combination of both.

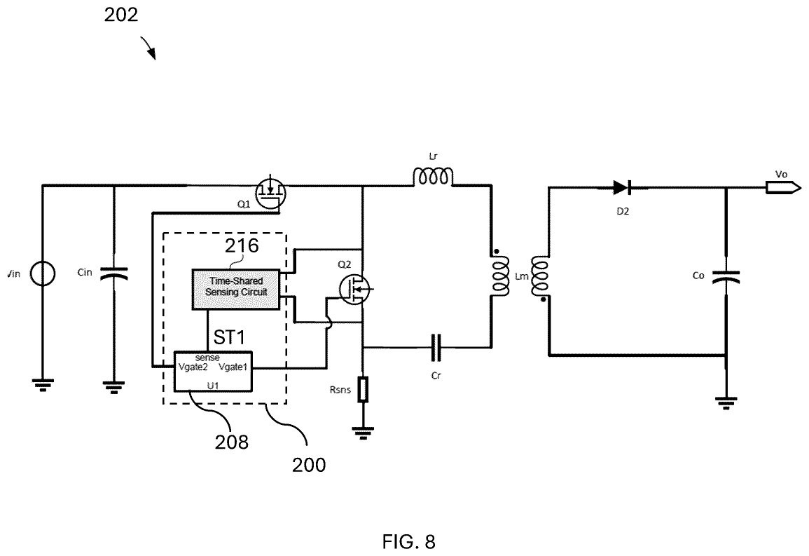

FIG. 8 is a schematic a further embodiment of the control system 200 for the switching converter 202, in accordance with a sixth embodiment of the present disclosure. The control system 200 of the present embodiment functions substantially as described for previous embodiments, in accordance with the understanding of the skilled person. In the present embodiment, the switching converter 202 is an asymmetric half bridge (AHB) switching power converter.

The previous example switching power converters were boost converters but the time-shared sensing circuit disclosed herein may be used for a single-terminal detection of the peak current conducted through the power switch transistor and also for valley-mode switching control of the power switch transistor in any suitable switching power converter.

The control module 208 includes a Vgate1 terminal coupled to a gate of a first power switch transistor Q1 and a Vgate2 terminal coupled to a gate of a second power switch transistor Q2. A time-shared sensing circuit 216 couples across the source and drain of the power switch transistor Q2 and also couples to the sense terminal ST1 of the control module 208. A drain of the power switch transistor Q2 couples to ground through a sense resistor Rsns.

The time-shared sensing circuit 216 may be implemented as described for any of the embodiments described herein, in accordance with the understanding of the skilled person.

With the time-shared sensing circuit 216 coupled to the sense terminal ST1 of the control module 208 in the AHB converter 200, the control module 208 may proceed to switch on either or both of the power switch transistors Q1 and Q2 in a valley-mode of operation. Similarly, the control module 206 may sense the peak current conducted through power switch transistor Q2 by sensing the sense resistor voltage through the sense terminal ST1 and switch off the power switch transistor Q2 accordingly.

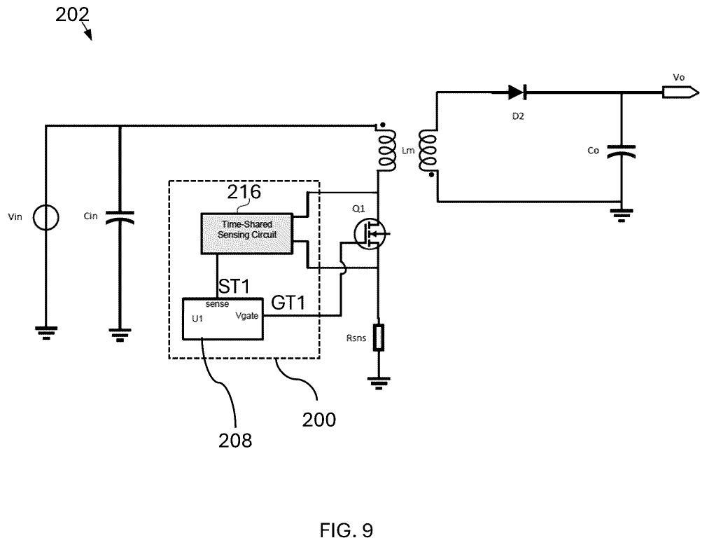

FIG. 9 is a schematic a further embodiment of the control system 200 for the switching converter 202, in accordance with a seventh embodiment of the present disclosure. The control system 200 of the present embodiment functions substantially as described for previous embodiments, in accordance with the understanding of the skilled person. In the present embodiment, the switching converter 202 is a flyback switching power converter.

The control module 208 includes a terminal GT1 coupled to a gate of a power switch transistor Q1 having a drain coupled to ground through a sense resistor Rsns. The time-shared sensing circuit 216 is coupled across the source and drain of the power switch transistor Q1 and also couples to the sense terminal ST1 of the control module 208.

The time-shared sensing circuit 216 may be implemented as described for any of the embodiments described herein, in accordance with the understanding of the skilled person.

With the time-shared sensing circuit 216 coupled to the sense terminal ST1 of the control module 208, the control module 208 may switch on the power switch transistor Q1 in a valley-mode of operation. Similarly, the control module 206 may sense the peak current conducted through power switch transistor Q1 by sensing the sense resistor voltage through the sense terminal ST1 and switch off the power switch transistor Q1 accordingly.

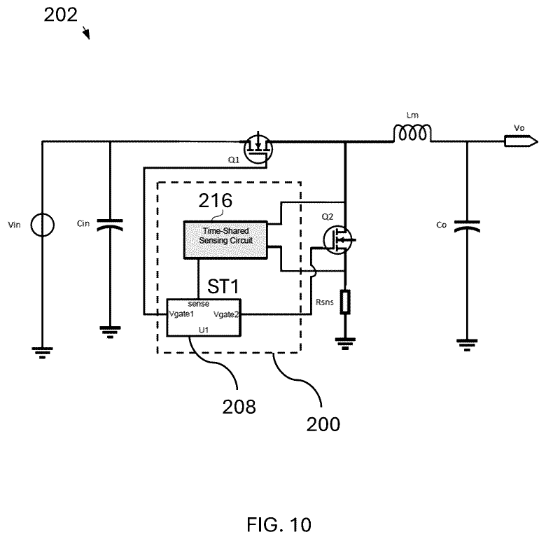

FIG. 10 is a schematic a further embodiment of the control system 200 for the switching converter 202, in accordance with an eighth embodiment of the present disclosure. The control system 200 of the present embodiment functions substantially as described for previous embodiments, in accordance with the understanding of the skilled person. In the present embodiment, the switching converter 202 is a buck converter.

The control module 208 includes a Vgate1 terminal coupled to a gate of a first power switch transistor Q1 and a Vgate2 terminal coupled to a gate of a second power switch transistor Q2. A drain of the power switch transistor Q2 couples to ground through a sense resistor Rsns. The time-shared sensing circuit 216 is coupled across the source and drain of the power switch transistor Q2 and is also coupled to the sense terminal ST1 of the control module 206.

The time-shared sensing circuit 216 may be implemented as described for any of the embodiments described herein, in accordance with the understanding of the skilled person.

With the time-shared sensing circuit 216 coupled to the sense terminal ST1 of the control module 206, the control module 206 may proceed to switch on one or both of the power switch transistor Q1, Q2 in a valley-mode of operation. Similarly, the control module 206 may sense the peak current conducted through power switch transistor Q2 by sensing the sense resistor voltage through the sense terminal ST1 and switch off the power switch transistor Q2 accordingly.

The sensing circuit 216 may be implemented using a series-type configuration or a parallel-type configuration. The sensing circuit 216 of the embodiments shown in FIG. 2A, FIG. 3A, FIG. 4, FIG. 5 are series-type configuration and the embodiment shown in FIG. 6 is a parallel-type configuration.

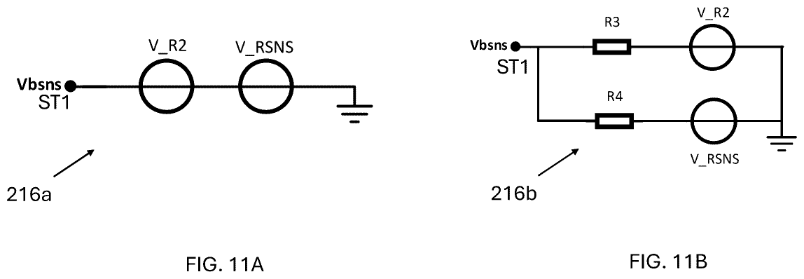

FIG. 11A is a schematic of an example series-type sensing circuit 216a. In a series-type configuration, the voltages across the resistor Rsns (V_RSNS) and the resistor R2 (V_R2) are combined in series before being sensed at the sense pin ST1 as the sense terminal voltage Vbsns.

Series-type sensing circuits lack flexibility in certain applications. In such cases, a parallel-type time-shared sensing circuit can be used. FIG. 11B is a schematic of an example parallel-type sensing circuit 216b.

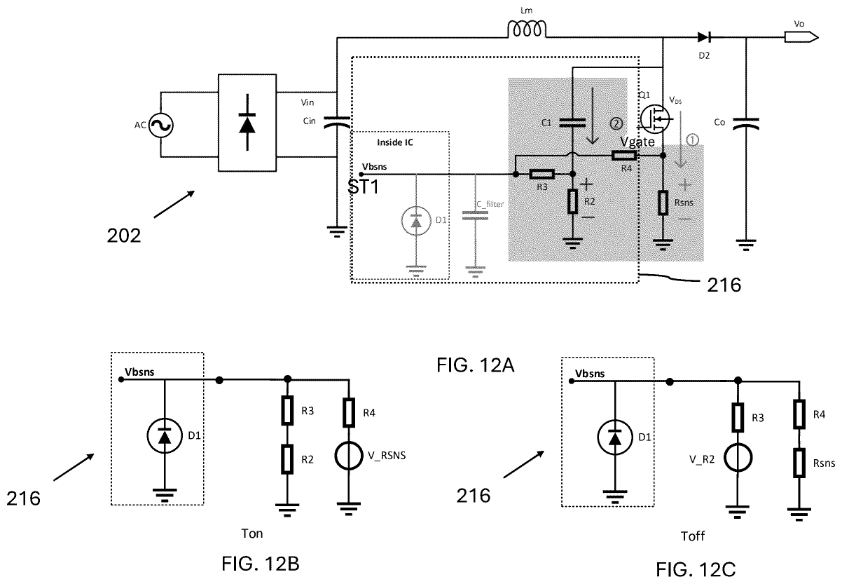

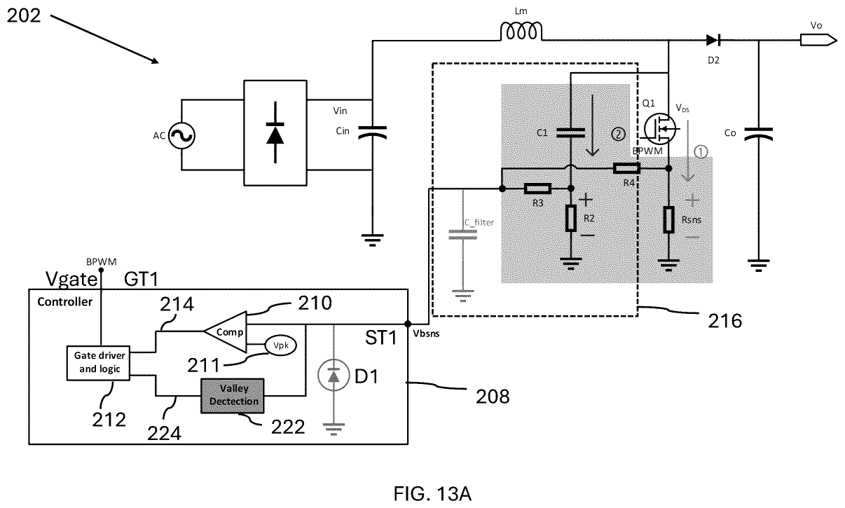

FIG. 12A is an alternative schematic of the embodiment presented in FIG. 6 and with the control module 208 omitted to aid in the clarity of the drawing. The present embodiment uses a parallel-type sensing circuit 216.

The resistor R2 is coupled to GND rather than source of power switch Q1, as is the case in the series-type configuration. The resistors R3 and R4 are added to give design flexibility in tuning the sensing gain and RC filter gain (with an optional capacitor filter C_filter) for different paths. The optional diode D1 is for clamping the negative voltage to protect the control system 200 integrated circuit (IC).

FIG. 12B is a schematic of the equivalent circuit of the sensing circuit 216 during the on time of the power switch Q1. The voltage Vbsns on the sensing pin ST1 of the IC (referred to as Vbsns on) during the on time is as follows:

$${V}_{bsns on} = {V}_{RSNS} * \frac{{R}_{3} + {R}_{2}}{{R}_{3} + {R}_{2} + {R}_{4}} \qquad ( 6 )$$

where V_{RSNS} is the voltage across the sense resistor Rsns. R₂, R₃ and R₄ are the resistances of the resistors R2, R3 and R4, respectively. The impact of the capacitor C1 on the equivalent circuit during the power switch Q1 on time is negligible.

FIG. 12C is a schematic of the equivalent circuit of the sensing circuit 216 during the off time of the power switch Q1. The voltage Vbsns on the sensing pin ST1 of the IC (referred to as V_{bsns off}) during the off time is as follows:

$${V}_{bsns off} = {V}_{R 2} * \frac{{R}_{4} + {R}_{sns}}{{R}_{4} + {R}_{sns} + {R}_{3}} \qquad ( 7 )$$

where V_{R2} is the voltage across the resistor R2.

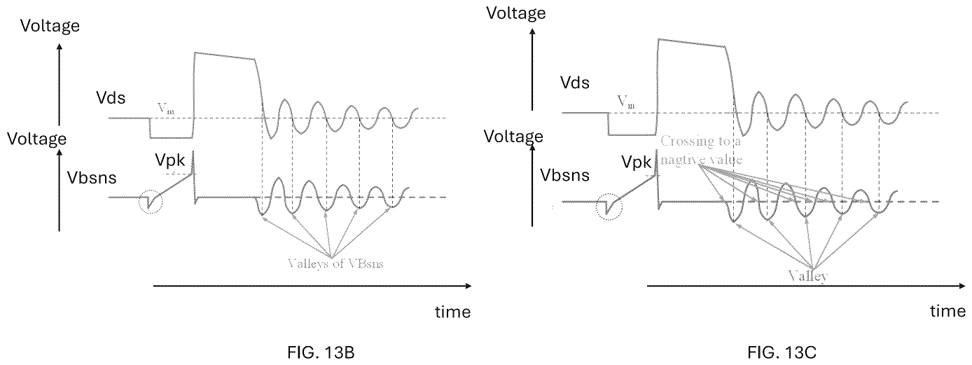

FIG. 13A is a schematic a further embodiment of the control system 200 for the switching converter 202, in accordance with a ninth embodiment of the present disclosure. The present embodiment shares features with the embodiment presented in FIG. 6 but has a different implementation of the control module 208.

In the present example, the voltage characteristic of the sense terminal voltage Vbsns is the local minimum of the sense terminal voltage Vbsns. Specifically, the voltage sense voltage sense circuit 222 is configured to detect the local minimum of the sense terminal voltage Vbsns.

By detecting the valley (local minimum) of the sense terminal voltage Vbsns during the off period of the power switch Q1, the time until the voltage valley (local minimum) of drain-to-source voltage Vds can be determined as a quarter of the ringing period (i.e. a quarter of the ringing period before the Vbsns crosses to positive).

This quarter-period advance timing allows the control module 208 IC to be ready to turn the power switch Q1 on near or at the drain-to-source Vds valley (local minimum), thereby improving EMI performance and power conversion efficiency.

For example, the delay time for turning on the switch Q1 after detection of the local minimum of the sense terminal voltage Vbsns may be set as a quarter of the ringing period, or other suitable time period to ensure that the power switch Q1 is turned on at, or near, the drain-to-source voltage Vds local minimum.

In summary, the control system 200 can detect the valley (local minimum) of the sense terminal voltage Vbsns or the crossing to a negative voltage (the negative zero crossing). This allows the control system 200 to determine the appropriate timing to send the turn-on signal in advance. Considering the turn-on delay of the switch Q1, the switching event can be triggered when the sense terminal voltage Vbsns is at or near the point at which it crosses to a positive voltage during the resonant oscillation of the drain-to-source voltage Vds.

The control module 208 may generate the gate driving signal Vgate in advance by considering the turn-on delay, thereby ensures that the power switch Q1 turns on when the sense terminal voltage Vbsns is near or at the crossing to positive point during a valley of the drain-to-source voltage Vds of the power switch Q1 in the resonant oscillation.

FIG. 13B is a timing graph showing example waveforms for a practical implementation of the control system 200 and the switching converter 202 of FIG. 13A as the power switch Q1 is switched from off to on, then from on to off. The graph is labelled showing the valleys in the sense terminal voltage Vbsns that may be detected.

FIG. 13C is a further timing graph showing example waveforms for a practical implementation of the control system 200 and the switching converter 202 of FIG. 13A as the power switch Q1 is switched from off to on, then from on to off. The graph is labelled showing the valleys in the sense terminal voltage Vbsns that may be detected. The graph is also labelled showing negative zero crossings which may be detected in further embodiments as described previously.

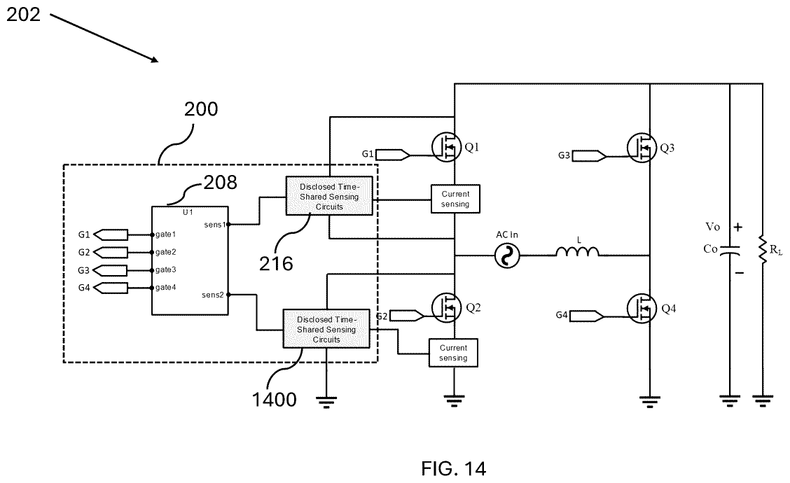

FIG. 14 is a schematic a further embodiment of the control system 200 for the switching converter 202, in accordance with a tenth embodiment of the present disclosure. In the present embodiment, the switching converter 202 is a Totem Pole PFC converter. In the present embodiment there is a further time-shared sensing circuit 1400 for monitoring the switch Q2. Both sensing circuits 216, 1400 are coupled to the control module 208 which drives the switching of the switches Q1, Q2 based on their respective time-shared sensing circuits.

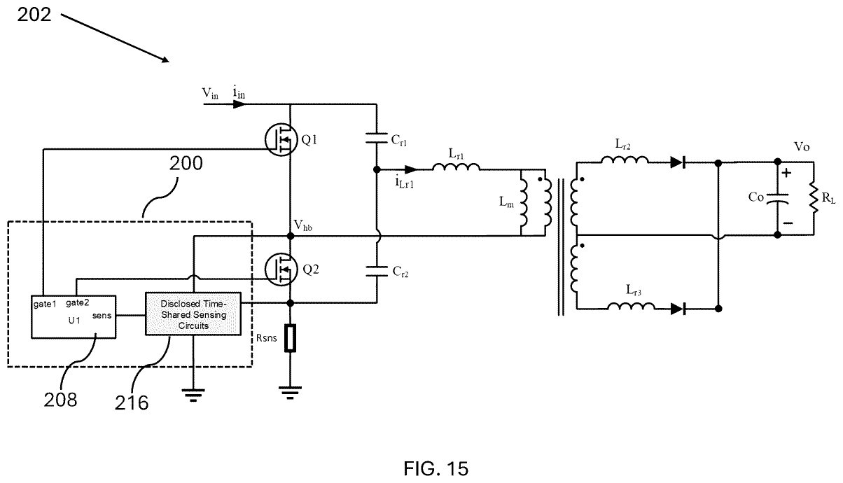

FIG. 15 is a schematic a further embodiment of the control system 200 for the switching converter 202, in accordance with an eleventh embodiment of the present disclosure. In the present embodiment, the switching converter 202 is a resonant DC/DC converter.

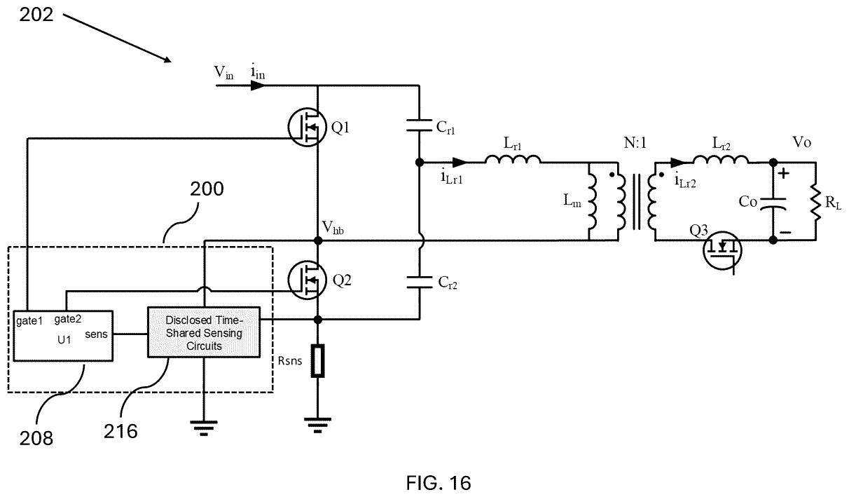

FIG. 16 is a schematic a further embodiment of the control system 200 for the switching converter 202, in accordance with a twelfth embodiment of the present disclosure. In the present embodiment, the switching converter 202 is a further resonant DC/DC converter.

In summary, embodiments of the sensing circuit 216 use a capacitor and resistor in series to sense the voltage oscillations of the drain voltage of power switches, while resistors are used to sense the current of the power switches. The sensed drain voltage and current signals are then combined into a single signal, either in series or parallel, and transmitted to the control module 206. Embodiments of the present disclosure may use a time-shared sensing circuit 216 having a series-type or parallel-type configurations.

In summary, embodiments of the present disclosure may have the switching power converter 202 being a boost converter but it will be appreciated that other types of switching power converters such as a buck, buck/boost, or a flyback converter may utilize the advantageous time-shared sensing disclosed herein. The control system 200 may be applied to AC/DC or DC/DC switching converters.

Various improvements and modifications may be made to the above without departing from the scope of the disclosure.

1. A control system for a switching converter comprising a first power switch, the control system comprising:
a control module comprising:
a sense terminal for receiving a sense terminal voltage; and
a gate terminal for providing a gate driving signal to drive the switching of the first power switch;
wherein the control module is configured to:
operate in a first mode in which the control module is configured to:
compare the sense terminal voltage with a peak threshold voltage; and
provide the gate driving signal to switch the first power switch to an off state when the sense terminal voltage and the peak threshold voltage are approximately equal; and
operate in a second mode in which the control module is configured to:
detect a voltage characteristic of the sense terminal voltage; and
provide the gate driving signal to switch the first power switch to an on state after a delay time has elapsed after detection of the voltage characteristic of the sense terminal voltage.

2. The control system of claim 1, wherein:
the first mode is whilst the first power switch is in the on state; and
the second mode is whilst the first power switch is in the off state and a voltage across the first power switch exhibits an oscillation.

3. The control system of claim 2, wherein the delay time is such that the first power switch is switched to the on state at, or near, a local minimum of the voltage across the first power switch.

4. The control system of claim 2, wherein the voltage across the first power switch that exhibits an oscillation during the second mode is the drain-to-source voltage of the first power switch or the drain-to-ground voltage of the first power switch.

5. The control system of claim 1, wherein the voltage characteristic of the sense terminal voltage is:
a negative zero crossing of the sense terminal voltage;
a local minimum of the sense terminal voltage; or
the sense terminal voltage being approximately equal to a second mode threshold voltage.

6. The control system of claim 5, wherein the second mode threshold voltage is a negative threshold voltage.

7. The control system of claim 1, wherein the control module is configured to:
detect consecutive zero crossings of the sense terminal voltage; and
the delay time is determined based on a difference between the consecutive zero crossings.

8. The control system of claim 1, wherein the control module comprises:
a first voltage sense circuit configured to:
compare the sense terminal voltage with the peak threshold voltage, and
provide a first output signal indicating when the sense terminal voltage and the peak threshold voltage are approximately equal;
a second voltage sense circuit configured to:
detect the voltage characteristic of the sense terminal voltage, and
provide a second output signal indicating that the voltage characteristic has been detected; and
a gate driver and logic circuit configured to:
receive the first and second output signals, and
provide the gate driving signal based on the received first and second output signals.

9. The control system of claim 8, wherein:
the second voltage sense circuit is configured to detect consecutive zero crossings of the sense terminal voltage; and
the delay time is determined based on a difference between the consecutive zero crossings.

10. The control system of claim 8, wherein:
the second voltage sense circuit is configured to provide the second output signal indicating that the voltage characteristic has been detected and that the delay time has elapsed after detection of the voltage characteristic;
such that the gate driver and logic circuit are configured to provide the gate driving signal to switch the first power switch to the on state after the delay time has elapsed after detection of the voltage characteristic, in response to the indication provided by the second output signal of the second voltage sense circuit.

11. The control system of claim 1, further comprising:
a sensing circuit for coupling to a first terminal and a second terminal of the first power switch;
wherein:
the sensing circuit is coupled to the sense terminal of the control module for providing the sense terminal voltage; and
the switching converter comprises a sense resistor coupled to the first power switch at its second terminal.

12. The control system of claim 11, wherein:
the sensing circuit comprises a first capacitor coupled between the first and second terminals of the first power switch; and
the second terminal of the power switch is coupled to the sense terminal of the control module.

13. The control system of claim 12, wherein:
the sensing circuit comprises a first resistor; and
the first capacitor is coupled to the second terminal of the first power switch via the first resistor.

14. The control system of claim 13, wherein:
the sensing circuit comprises a second resistor; and
the first capacitor is coupled to the sensing terminal of the control module via the second resistor.

15. The control system of claim 11, wherein the sensing circuit comprises:
a first capacitor and a first resistor coupled in series between the first terminal of the first power switch and a ground terminal;
a second resistor coupled between the sense terminal and a first node between the first capacitor and the first resistor; and
a third resistor coupled between the sense terminal and the second terminal of the first power switch.

16. The control system of claim 1, wherein the switching converter is:
a buck converter;
a boost converter;
a buck-boost converter;
a flyback converter; or
an asymmetric half bridge converter.

17. The control system of claim 1, wherein the switching converter is a boost converter comprising:
an inductor;
an output capacitor; and
an output diode comprising an anode coupled to the inductor and comprising a cathode coupled to the output capacitor.

18. The control system of claim 1, wherein the switching converter is configured to receive an input voltage from a rectifier configured to rectify an AC supply voltage to provide the input voltage.

19. A method of controlling a switching converter comprising a first power switch using a control system comprising a control module comprising a sense terminal for receiving a sense terminal voltage, and a gate terminal for providing a gate driving signal to drive the switching of the first power switch, the method comprising:
operating the control module in a first mode by:
comparing the sense terminal voltage with a peak threshold voltage, and
providing the gate driving signal to switch the first power switch to an off state when the sense terminal voltage and the peak threshold voltage are approximately equal; and
operating the control module in a second mode by:
detecting a voltage characteristic of the sense terminal voltage, and
providing the gate driving signal to switch the first power switch to an on state after a delay time has elapsed after detection of the voltage characteristic of the sense terminal voltage.

20. A switching converter apparatus comprising:
a switching converter comprising a first power switch; and
a control system comprising a control module comprising:
a sense terminal for receiving a sense terminal voltage; and
a gate terminal for providing a gate driving signal to drive the switching of the first power switch;
wherein the control module is configured to:
operate in a first mode in which the control module is configured to:
compare the sense terminal voltage with a peak threshold voltage, and
provide the gate driving signal to switch the first power switch to an off state when the sense terminal voltage and the peak threshold voltage are approximately equal; and
operate in a second mode in which the control module is configured to:
detect a voltage characteristic of the sense terminal voltage, and
provide the gate driving signal to switch the first power switch to an on state after a delay time has elapsed after detection of the voltage characteristic of the sense terminal voltage.
